(19) United States
(12) Patent Application Publication
(10) Pub. No.: US 2004/0080397 A1
(43) Pub. Date: Apr. 29, 2004

(54) Method of protecting a thick film resistor

(76) Inventors: Mike Cubon, Northfield, IL (US); Jose A. Martinez, Franklin Park, IL (US); Ksawera Saletnik, Des Plaines, IL (US)

Correspondence Address: Paul F. Donovan, Illinois Tool Works Inc., 3600 West Lake Avenue, Glenview, IL, 60025, US

(21) Appl. No.: 10/280,197

(22) Filed: Oct. 25, 2002

(51) Int. Cl. H01C 1/012; H01C 10/30

(52) U.S. Cl. 338/307; 338/320; 338/309; 338/160

(57) ABSTRACT

A method of protecting a thick film resistor, including the steps of: providing a substrate having a plurality of conductive elements thereon; applying an electrically resistive material to a surface of the substrate, thereby forming the thick film resistor, the resistive material being electrically connected to at least one corresponding conductive element; curing the resistive material; and applying a coating over at least a substantial portion of the resistive material.

### FIELD OF THE INVENTION

The present invention relates to an apparatus and a method for protecting a resistor, and, more particularly, to a method and apparatus for protecting a thick film resistor with a coating.

### BACKGROUND OF THE INVENTION

Thick film resistors are employed in numerous hybrid electronic circuits in a wide range of resistor values. Thick film resistors can be formed by printing methods, such as screen-printing, in which a thick film resistive paste or ink is deposited upon a substrate. The substrate may be a printed wiring board, a flexible circuit, a ceramic substrate or a silicon substrate. Thick film inks or pastes typically include an electrically conductive material, various additives to affect the final electrical properties of the resistor, an organic binder and an organic vehicle. After printing a thick film paste on a substrate, the assembly typically is heated to dry the ink and convert it into a suitable film that adheres to the substrate. If polymer thick film ink is used, the organic binder is a polymer matrix material, and the heating serves to remove the organic vehicle and to cure the polymer material.

Conventional screen-printing techniques generally employ a template with apertures therein. Each aperture is an opening that reflects the size and shape of the resistor to be created. The template, often referred to as a screening mask, is placed in close proximity to the surface of the substrate on which the resistor is to be printed. The mask is then loaded with a polymer thick film ink, and a squeegee blade is drawn across the surface of the mask to press the ink through the apertures and onto the surface of the substrate.

Copper terminations for the polymer thick film ink are typically formed prior to deposition of the ink by laminating copper foil to a substrate with subtractive etching to remove unwanted copper. Another method of placing conductive paths on a substrate includes screen-printing using a conductive polymer thick film ink, which is typically applied prior to the application of a resistive polymer thick film ink. Conductive ink is separately cured prior to the printing of the polymer thick film resistive ink.

Applying a polymer thick film resistive ink on a printed wiring board, otherwise known as a printed circuit board, allows resistive elements to be printed directly on the printed circuit board. The porosity of a polymer thick film resistor can result in moisture entrapment when the resistor is exposed to an atmosphere containing moisture. Another problem is that oxidation occurs between the interface of the polymer thick film resistor and the conductor. Still another problem is the interaction of the polymer thick film with any chemicals to which the polymer thick film resistor may be exposed. Each of these problems causes undesirable charges to the electrical characteristics of the thick film resistors.

What is needed in the art is a method for protecting a thick file resistor, to reduce the environmental sensitivity of the thick film resistor.

### SUMMARY OF THE INVENTION

The present invention provides a method for coating a thick film resistor.

The invention comprises, in one form thereof, a method of protecting a thick film resistor, including steps of: providing a substrate having a plurality of conductive elements thereon; applying an electrically resistive material to a surface of the substrate, thereby forming the thick film resistor, the resistive material being electrically connected to at least one corresponding conductive element; curing the resistive material; and applying a coating over at least a substantial portion of the resistive material.

The invention comprises, in yet another form thereof, a circuit board assembly including: a substrate, a plurality of conductive elements applied to the substrate, at least one resistor applied to a surface of the substrate, at least one resistor electrically connected to at least one of the plurality of conductive elements and a coating applied over substantially all of at least one resistor.

An advantage of the present invention is protecting a thick film resistor from moisture in the environment.

Another advantage of the present invention is that oxidation between the interface of the thick film resistor and a conductive path is reduced by preventing the proximity of oxygen with the interface.

Yet another advantage of the present invention is that resistor variability is reduced in that the thick film material that is part of the resistor is isolated from any chemicals in the environment.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a printed circuit board assembly employing an embodiment of the method of the present invention;

FIG. 2 is a thick film resistor of the circuit board assembly of FIG. 1;

FIG. 3 is a cross-sectional view along section line 3-3 of the resistor of FIG. 2; and

FIG. 4 represents a flow chart of a method employed in coating the thick film resistor of FIGS. 1-3.

Before the embodiments of the invention are explained in detail, it is to be understood that the invention is not limited in its application to the details of construction and the arrangements of the components set forth in the following description, or illustrated in the drawings. The invention is capable of other embodiments and of being practiced or being carried out in various ways. Also, it is understood that the phraseology and terminology used herein are for the purpose of description, and should not be regarded as limiting. The use of “including” and “comprising” and variations thereof herein is meant to encompass the items listed thereafter and equivalents thereof, as well as additional items and equivalents thereof.

### DETAILED DESCRIPTION OF THE PREFERRED EMBODIMENT

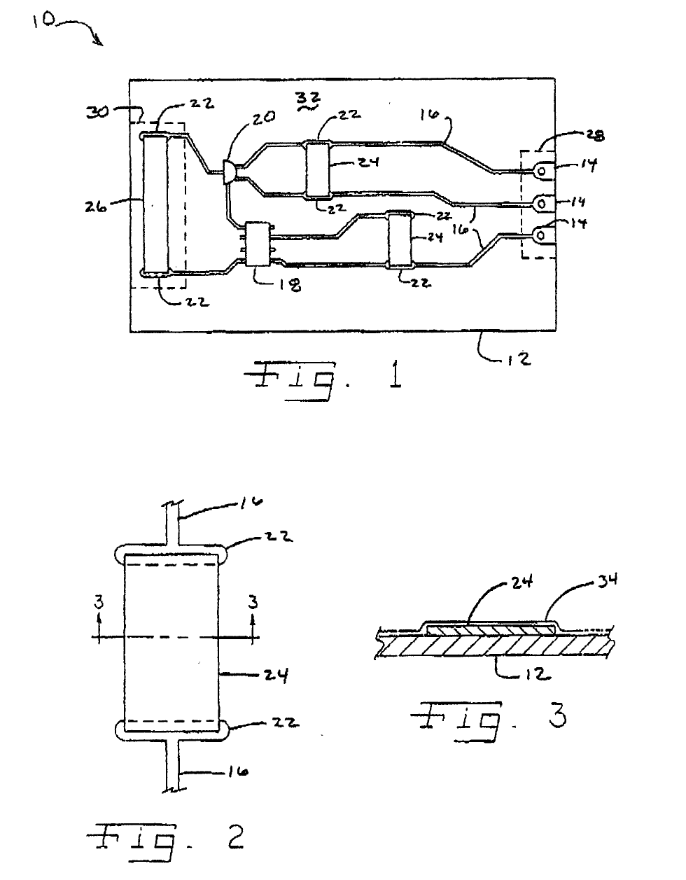

Referring now to the drawings, and more particularly to FIG. 1, there is shown an electronic circuit board assembly 10 embodying the present invention. Circuit board assembly 10 includes a substrate 12, connective pads 14, conductive trace 16, an integrated circuit 18, a transistor 20, conductive pads 22, resistors 24, a resistor 26, uncoated areas 28 and 30 and coated area 32. Circuit board assembly 10 includes various circuit elements and a way of being electrically connecting to other circuit boards and/or wiring harnesses by way of connective pads 14. Circuit board assembly 10 allows for an electrical connection to printed resistor 26 in the form of a conductive contact (not shown) that runs along the surface of printed resistor 26.

Substrate 12 also known as printed circuit board 12 includes a non-conductive element, which may be an epoxy filled fiberglass or a flexible material also known as a flex circuit. Substrate 12 has a non-conductive surface with relatively good adherence properties for the adherence of connective pad 14, conductive trace 16, conductive pads 22 and resistors 24 and 26. Substrate 12 may also be in the form of ceramic, silicon or plastic material.

Connective pads 14 are a conductive material, such as copper, that is applied to substrate 12 or is a material that remains on circuit board 12 after an etching process. Connective pads 14 are electrically connected to conductive traces 16 and provide for electrical connection, by way of soldering or physical contact, with another electrical circuit element. Connective pads 14 are shown along one side of substrate 12 even though connective pads 14 may be placed at any point on substrate 12 or along multiple edges of substrate 12.

Conductive traces 16 are made of copper, or of some other conductive material that is electrically conductive, and are positioned in accordance with a pattern that routes electricity about circuit board assembly 10. Conductive traces 16 may be formed on multiple layers of printed circuit board 12, and electrically connect connective pads 14, conductive pads 22 and various circuit elements in circuit board assembly 10. Conductive traces 16 are a conductive material that is either selectively deposited or is the remaining material after a chemical etch of circuit board 12. Alternatively, conductive traces 16 may be made of a conductive thick film ink that is screen printed and cured on substrate 12.

Integrated circuit 18 is a multi-functional circuit element that is soldered to conductive traces 16 or to pads provided for the insertion of pins of integrated circuit 18 through printed circuit board 12. In a like manner, transistor 20 is mounted as a discrete component on printed circuit board 12, and is electrically connected by way of conductive traces 16 to other electrical components.

Conductive pads 22 are electrically connected to certain corresponding conductive traces 16 in accordance with the circuit requirements. Conductive pads 22 are made of the same material as conductive trace 16 or alternatively may be made of conductive thick film ink deposited upon a conductive trace 16. Conductive pads 22 are positioned for receiving and electrically connecting to printed resistors 24 and 26. Conductive pads 22 are typically wider than the width of printed resistors 24 and 26 to accommodate positioning and manufacturing variances.

Resistors 24 and 26 are made of a polymer thick film (PTF) material although another resistive material may be used. Polymer thick film resistor material includes electrically conductive material as well as an organic binder and an organic vehicle. Resistors 24 and 26 may be applied to substrate 12 using a screen-printing method, a pad printing method, a spraying technique or another technique so as to deposit PTF material on circuit board 12. Once applied to substrate 12, resistors 24 and 26 are in continuous intimate physical contact with substrate 12. Resistors 24 and 26 may be made of different formulations of material since resistors 24 will be covered by coating 34 and resistor 26 will be left uncoated in order to allow electrical contact with a conductive contact (not shown). Resistor 26 may have some abrasion resistance or lubricity characteristics, which are unnecessary with resistors 24. Once resistors 24 and 26 are applied to circuit board 12 and are properly cured, a coating 34 is applied to selected portions of circuit board 12 as represented by reference number 32. Certain sections, such as uncoated areas 28 and 30, are not coated by coating 34 to allow for subsequent electrical interaction with other electrical components or for interconnection with other electrical conductors.

Referring to FIGS. 2 and 3, there is shown resistor 24 with coating 34 thereon. Coating 34 may be an encapsulating compound, a solder mask or a dielectric material. Coating 34 is completely or at least substantially impermeable to gases and vapors. The application of coating 34 reduces or eliminates gas and vapor contact with resistors 24. Moisture and other chemical contaminants can affect the resistivity of resistors 24 and cause a shift in the electrical characteristics. In the prior art, resistors 24 were not coated to allow for heat dissipation. However, testing of uncoated and coated resistors has demonstrated a reduction in the variability of resistors when protected from moisture and chemical elements. Tables 1 and 2 that follow illustrate shifts in resistive values for 16 and 32 Ohm test resistors that were exposed to a humid environment. A set of thick film resistors having coating 34 applied was tested and compared with a similar set of thick film resistors without a coating.

TABLE 1
Resistor value shift with coating

| Before | After | Shift | Before | After | Shift |
|---|---|---|---|---|---|
| 16 Ohm | 16 Ohm | 16 Ohm | 32 Ohm | 32 Ohm | 32 Ohm |
| 15.2 | 15.9 | 0.7 | 32.8 | 34.1 | 1.3 |
| 15.0 | 15.9 | 0.9 | 33.0 | 34.5 | 1.5 |
| 15.0 | 15.7 | 0.7 | 33.7 | 34.9 | 1.2 |
| 15.8 | 16.4 | 0.6 | 35.0 | 36.6 | 1.6 |
| 16.1 | 16.8 | 0.7 | 35.8 | 37.4 | 1.6 |
| 16.2 | 16.9 | 0.7 | 34.6 | 36.2 | 1.7 |
| 14.9 | 15.6 | 0.7 | 32.6 | 33.9 | 1.3 |
| 14.7 | 15.7 | 1.0 | 32.6 | 34.1 | 1.5 |
| 14.7 | 15.5 | 0.8 | 33.0 | 34.3 | 1.3 |
| 15.7 | 16.4 | 0.7 | 34.3 | 35.8 | 1.5 |
| 15.7 | 16.4 | 0.7 | 34.9 | 36.4 | 1.5 |
| 16.2 | 16.9 | 0.7 | 33.9 | 35.2 | 1.3 |
| 16.4 | 17.4 | 1.0 | 35.5 | 36.9 | 1.4 |
| 14.5 | 15.3 | 0.8 | 32.8 | 34.3 | 1.5 |
| 14.5 | 15.1 | 0.6 | 31.9 | 33.2 | 1.3 |
| 15.6 | 16.3 | 0.7 | 34.8 | 36.3 | 1.5 |
| 15.9 | 16.6 | 0.7 | 34.3 | 35.6 | 1.3 |
| 16.4 | 17.0 | 0.6 | 33.5 | 35.5 | 2.0 |
| 17.0 | 17.7 | 0.7 | 36.3 | 37.7 | 1.4 |
| 15.6 | 16.5 | 0.9 | 33.8 | 35.3 | 1.5 |
| 15.9 | 16.4 | 0.5 | 34.2 | 35.7 | 1.5 |
| 15.4 | 15.9 | 0.5 | 35.5 | 36.9 | 1.4 |
| 16.3 | 17.1 | 0.8 | 35.8 | 37.4 | 1.6 |
| 16.3 | 17.1 | 0.8 | 33.1 | 34.7 | 1.6 |
| 16.9 | 17.9 | 1.0 | 36.6 | 39.3 | 2.7 |
| 16.5 | 17.3 | 0.8 | 34.9 | 36.4 | 1.5 |
| 16.2 | 17.0 | 0.8 | 34.5 | 36.0 | 1.5 |
| 16.4 | 17.3 | 0.9 | 35.7 | 37.3 | 1.6 |
| 16.7 | 17.5 | 0.8 | 36.4 | 38.1 | 1.7 |
| 16.1 | 16.9 | 0.8 | 33.8 | 36.8 | 2.0 |

| | | | |
|---|---|---|---|
| Avg. Deviation | 0.753 | Avg. Deviation | 1.542 |
| Min. | 0.5 | Min. | 1.2 |
| Max. | 1.0 | Max. | 2.7 |

TABLE 2
Resistor value shift without coating

| Before | After | Shift | Before | After | Shift |
|---|---|---|---|---|---|
| 16 Ohm | 16 Ohm | 16 Ohm | 32 Ohm | 32 Ohm | 32 Ohm |
| 17.2 | 17.0 | 0.2 | 35.0 | 35.3 | 0.3 |
| 18.5 | 18.0 | 0.5 | 35.9 | 36.4 | 0.5 |
| 17.3 | 17.6 | 0.3 | 35.4 | 43.6 | 8.2 |
| 18.2 | 17.7 | 0.5 | 36.2 | 36.8 | 0.6 |
| 18.2 | 20.5 | 2.3 | 36.5 | 37.8 | 1.3 |
| 18.1 | 19.7 | 1.6 | 37.0 | 41.0 | 4.0 |
| 18.5 | 18.3 | 0.2 | 36.4 | 37.0 | 0.6 |
| 18.3 | 19.5 | 1.2 | 35.9 | 35.5 | 0.4 |
| 17.0 | 18.1 | 1.1 | 35.8 | 38.5 | 2.7 |
| 18.7 | 21.4 | 2.7 | 36.8 | 38.5 | 1.7 |
| 18.2 | 19.1 | 0.9 | 36.1 | 42.0 | 5.9 |
| 18.6 | 23.2 | 4.6 | 39.1 | 49.4 | 10.3 |
| 19.0 | 20.2 | 1.2 | 38.3 | 39.0 | 0.7 |
| 18.9 | 18.9 | 0.0 | 36.0 | 38.1 | 2.1 |
| 17.4 | 19.8 | 2.4 | 35.8 | 38.7 | 2.9 |
| 18.6 | 19.7 | 1.1 | 36.9 | 37.1 | 0.2 |
| 18.6 | 22.3 | 3.8 | 38.3 | 40.7 | 2.4 |
| 19.8 | 23.1 | 3.3 | 39.9 | 46.6 | 6.7 |
| 19.3 | 19.2 | 0.1 | 38.4 | 40.6 | 2.2 |
| 19.2 | 19.1 | 0.1 | 38.5 | 38.9 | 0.4 |
| 19.0 | 19.4 | 0.4 | 37.1 | 37.7 | 0.6 |
| 18.6 | 18.3 | 0.3 | 37.4 | 38.3 | 0.9 |
| 19.8 | 20.3 | 0.5 | 39.9 | 40.6 | 0.7 |
| 20.6 | 23.9 | 3.3 | 40.5 | 44.3 | 3.8 |
| 20.4 | 21.3 | 0.9 | 40.7 | 41.2 | 0.5 |
| 21.2 | 21.6 | 0.4 | 41.0 | 41.6 | 0.6 |
| 20.2 | 20.4 | 0.2 | 40.0 | 44.4 | 4.4 |
| 20.5 | 21.4 | 0.9 | 41.3 | 45.2 | 3.9 |
| 20.9 | 21.3 | 0.4 | 42.9 | 45.4 | 2.5 |
| 21.2 | 22.7 | 1.5 | 42.7 | 44.1 | 1.4 |

| | | | |
|---|---|---|---|
| Avg. Deviation | 1.228 | Avg. Deviation | 2.447 |
| Min. | 0.0 | Min. | 0.2 |
| Max. | 4.6 | Max. | 10.3 |

The first and fourth columns of each table contain the resistive value for each resistor prior to exposure to the test environment. The second and fifth columns contain the measurements for each respective resistor after exposure to the test environment. The third and sixth columns indicate the shift in resistance value for each respective resistor. Thirty nominal 16 Ohm and thirty nominal 32 Ohm resistors were tested with a coating and another thirty 16 Ohm and thirty 32 Ohm resistors were tested without coating. All resisters were exposed to the same environmental conditions. The resistors were exposed to ninety-six hours of cycling from 25° C. to 65° C. in a humidity of greater than 90%. Samples were subjected to periods of power and no power. Samples also were subjected to a moisture susceptibility environment, where the circuit boards with the sample resistors thereon were placed in a −40° C. environment for thirty minutes. Then the boards were placed in a 65° C. environment with 95% relative humidity for two minutes and tested under power in the 95% relative humidity condition for three minutes. Table 1 illustrates a shift in resistor values for those resistors having a coating. The data indicates a shift in the 16 Ohm resistors of from 0.5 Ohms to 1.0 Ohm with an average deviation of 0.753 Ohms. In contrast 16 Ohm resistors without coating, as illustrated in Table 2, have an average deviation of 1.228 Ohms. In a like manner, the 32 Ohm resistors having a coating show an average deviation of 1.54 Ohms versus 2.45 Ohms for the 32 Ohm resistors. In each case the maximum shift of the resistors without coating is approximately four times the maximum shift of resistors having coating thereon.

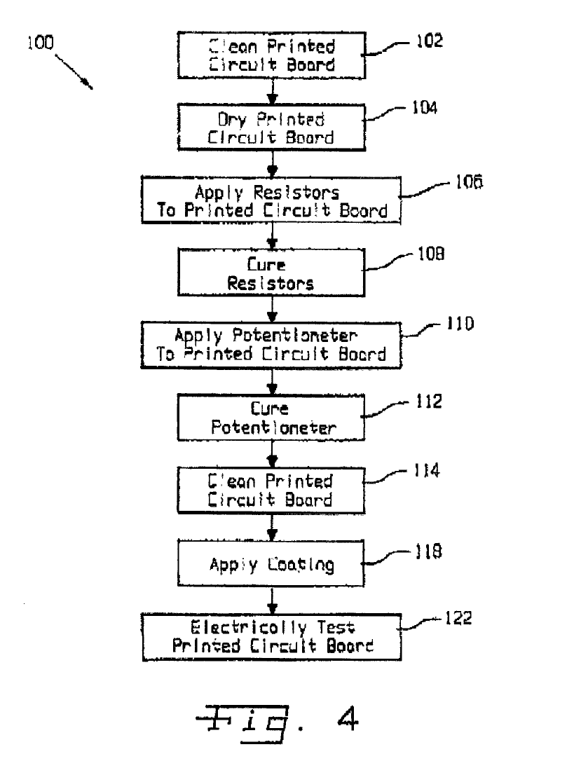

Now, additionally referring to FIG. 4, there is shown a block diagram representing a method of the present invention used to apply a coating to resistors 24 and 26. The method of FIG. 4 is depicted by a plurality of processing steps hereinafter referred to as process 100.

At the point of beginning of process 100, and specifically at step 102, circuit board 12 is cleaned using a solvent or other cleaning method to remove all contamination from circuit board 12. Once circuit board 12 is cleaned, process 100 continues to step 104.

At step 104, printed circuit board 12 is dried either in a room temperature environment or in a drying oven. Once printed circuit board 12 is dry, process 100 continues to step 106.

At step 106, resistors 24 are applied to circuit board 12 such that they are connected to conductive pads 22 on circuit board 12. Resistors 24 may be applied using a screen-printing method, a pad printing method or by directing a spray of PTF material onto circuit board 12. Process 100 then continues to step 108.

At step 108, resistors 24 are cured by placing circuit board 12 in an infrared oven for several minutes at a temperature between 200° C. and 300° C. The curing process removes a substantial amount of the organic vehicle from resistors 24. Once resistors 24 are cured, process 100 then continues to step 110.

At step 110, resistor 26, also known as potentiometer 26 is applied to circuit board 12 by screen-printing, pad printing or spraying PTF material onto circuit board 12. Resistor 26 is in the form of a potentiometer, which has a conductive contact (not shown) either exterior to circuit board 12 or connected thereto that traverses the surface of resistor 26 thereby conducting a potential to the conductive contact. Process 100 then continues to step 112.

At step 112, resistor 26 is cured by placing circuit board 12 in an infrared oven at a temperature between 200° C. and 300° C. for the removal of most, if not all, of an organic vehicle that is contained in the PTF material. Process 100 then continues to step 114.

At step 114, printed circuit board 12 is subjected to a cleaning operation, which involves solvents and air-drying to clean circuit board 12. The cleaning of circuit board 12 removes copper oxidation, which may be present as a result of some of the applications of resistive inks and/or the curing process. Cleaning printed circuit board 12 also enhances the adherence of coating 34 to be applied at step 118.

Coating is selectively applied. Selected areas are masked as a result.

At step 118, coating 34 is applied to circuit board 12, particularly to coated area 32. The application of coating 34 to coated area 32 is implemented by brushing, spraying, screen-printing, dipping or pad printing. Alternatively, coating 34 may be applied to coated area 32 with a numerically controlled device, which selectively coats area 32 on circuit board 12, leaving uncoated areas 28 and 30 without coating. Coating 34 conforms to the surface and/or component to which it is applied. Where applied, coating 34 is in continuous intimate physical contact with resistor 24, conductor 16, conductive pads 22 and substrate 12. Coating 34 includes at least one of a dielectric material, an encapsulant, a conformal coating or a solder mask type material. Coating 34 adheres to the surface of substrate 12, resistors 24 and conductors 16 as coating 34 cures.

At step 122, circuit board 12 is electrically tested by selectively applying electrical voltages, currents and/or signals to connective pads 14 and to the surface of resistor 26. Process 100 is then complete, and circuit board assembly 10 is entered into the manufacturing flow, being subject to other manufacturing processes or assembly procedures.

Coating 34 advantageously reduces the environmental impact due to the atmospheric contact with resistors 24. Also, advantageously, coating 34 prevents oxygen from reaching the interface of conductive pads 22 and resistors 24, thereby reducing oxidation at that juncture. The resulting protection by coating 34 limits the variability of resistors 26 due to environmental variations, thereby providing a more stable electrical circuit on circuit board assembly 10.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A method of protecting a thick film resistor, comprising the steps of:
providing a substrate having a plurality of conductive elements thereon;
applying an electrically resistive material to a surface of said substrate, thereby forming said thick film resistor, said resistive material being electrically connected to at least one corresponding said conductive element;
curing said resistive material; and
applying a coating over at least a substantial portion of said resistive material.

2. The method of claim 1, further comprising the step of cleaning said substrate prior to said applying a coating step.

3. The method of claim 1, wherein said coating is one of a dielectric material, an encapsulant and a solder mask.

4. The method of claim 1, wherein said resistive material is applied to said surface of said substrate by one of screen-printing, pad printing and spraying.

5. The method of claim 1, wherein said coating is applied by one of screen-printing, pad printing, brushing, dipping and spraying.

6. The method of claim 1, wherein said applying a coating step is comprised of the step of selectively applying said coating to a portion of said substrate.

7. The method of claim 1, wherein said coating is applied such that said coating is in continuous intimate physical contact with said resistive material.

8. A circuit board assembly, comprising:
a substrate;
a plurality of conductive elements applied to said substrate;
at least one resistor applied to a surface of said substrate, said at least one resistor electrically connected to at least one of said plurality of conductive elements; and
a coating applied over substantially all of at least one said resistor.

9. The circuit board assembly of claim 8, wherein said coating is one of a dielectric material, an encapsulant and a solder mask.

10. The circuit board assembly of claim 8, wherein said substrate is made of fiberglass.

11. The circuit board assembly of claim 8, wherein said at least one resistor is applied to said surface of said substrate by one of screen-printing, pad printing and spraying.

12. The circuit board assembly of claim 8, wherein said coating is applied by one of screen-printing, pad printing, brushing, dipping and spraying.

13. The circuit board assembly of claim 8, wherein said coating is substantially impermeable.

14. The circuit board assembly of claim 8, wherein said plurality of conductive elements are at least one of etched copper and polymer thick film.

15. The circuit board assembly of claim 8, wherein said coating is in continuous intimate physical contact with at least one said resistor.

16. The circuit board assembly of claim 8, wherein said coating selectively applied to a portion of said substrate.

17. A circuit board assembly, comprising:
a substrate;
a plurality of conductive elements applied to said substrate;
at least one polymeric thick film resistor applied to a surface of said substrate, said at least one polymeric thick film resistor electrically connected to at least one of said plurality of conductive elements; and
a coating applied over substantially all of at least one said polymeric thick film resistor.

18. The circuit board assembly of claim 17, wherein said coating is one of a dielectric material, an encapsulant and a solder mask.

19. The circuit board assembly of claim 17, wherein said at least one polymeric thick film resistor is applied to said surface of said substrate by one of screen-printing, pad printing and spraying.

20. The circuit board assembly of claim 17, wherein said coating is applied by one of screen-printing, pad printing, brushing, dipping and spraying.
